(19) United States
(12) Patent Application Publication
(10) Pub. No.: US 2026/0039537 A1
(43) Pub. Date: Feb. 5, 2026

(54) AI-BASED SYSTEM FOR ROOT CAUSE ANALYSES OF OPERATIONAL ANOMALIES IN WIRELESS NETWORKS

(71) Applicant: T-MOBILE INNOVATIONS LLC, Overland Park, KS (US)

(72) Inventors: Rafal Lazarczyk, Mission, KS (US); Sharath Somashekar, Overland Park, KS (US); Jennifer Feria Reyes, Bothell, WA (US); Shane Michael Metcalf, Duvall, WA (US)

(21) Appl. No.: 18/788,360

(22) Filed: Jul. 30, 2024

(51) Int. Cl. H04L 41/0631; H04L 41/16; H04L 43/16

(52) U.S. Cl. CPC H04L 41/0631; H04L 41/16; H04L 43/16

(57) ABSTRACT

Technology is disclosed herein for diagnosing root causes of operational anomalies on wireless networks in various implementations. In one example, program instructions direct a computing apparatus to detect an operational anomaly in a wireless network based on error code information and capture network operations data and contextual information relating to the operational anomaly. The program instructions further direct the computing apparatus to prompt an AI model to identify a root cause of the operational anomaly based on the error code information, the network operations data, and the contextual information and to receive output from the AI model including a root cause analysis of the operational anomaly.

### TECHNICAL FIELD

Aspects of the disclosure are related to the field of wireless communication networks, particularly operational diagnostics.

### BACKGROUND

In wireless communication networks, data transactions for call flows transit a number of control plane and user plane nodes the interfaces of which are monitored to ensure the quality and reliability of IMS and data service. To diagnose a malfunction on a network, data is captured from packet sniffers at the interfaces and from the network functions themselves, then examined to isolate the location and cause of the malfunction. Typically, a network administrator with expertise in a particular area of the network will examine the captured data to hone in on the issue. However, when a malfunction occurs on the network, the failure can cascade through the network, causing error codes or signals to be transmitted from multiple nodes of the network. Thus, diagnosing the issue means unraveling a chain of events at the multiple nodes, requiring the coordinated efforts of multiple network administrators with expertise in different network domains. Add to this the fact that typically a large quantity of operations data is captured and must be examined in order to ascertain the root cause or triggering event. In sum, diagnosing a malfunction on a wireless network can be a time-consuming and labor-intensive process.

As network administrators gain experience in a particular domain of the network, such expertise can facilitate the process of diagnosing an issue on the network. For example, experienced administrators are able to diagnose issues based on having developed an intuition for patterns of behavior in the operations data, even data which is not in a human-readable form. This means that ensuring the quality and reliability of the network relies, often heavily, on individuals developing the knowledge and experience to diagnose issues. However, such expertise may take years of experience to develop and is not readily transferable.

### OVERVIEW

Technology is disclosed herein for diagnosing root causes of operational anomalies on wireless networks in various implementations. In one example, a computing apparatus comprises one or more computer readable storage media, one or more processors operatively coupled with the one or more computer readable storage media and program instructions stored on the one or more computer readable storage media that, when executed by the one or more processors and direct the computing apparatus to detect an operational anomaly in a wireless network based on error code information and capture network operations data and the contextual information relating to the operational anomaly. The program instructions further direct the computing apparatus to prompt an AI model to identify a root cause of the operational anomaly based on the error code information, the network operations data, and contextual information and to receive output from the AI model including a root cause analysis of the operational anomaly.

In another example, a method of operating a computing device comprises detecting an operational anomaly in a wireless network based on error code information and capturing network operations data and contextual information relating to the operational anomaly. The method continues with prompting an AI model to identify a root cause of the operational anomaly based on the error code information, the network operations data, and the contextual information and receiving output from the AI model including a root cause analysis of the operational anomaly.

In yet another example of the technology disclosed herein, one or more computer readable storage media having program instructions stored thereon that, when executed by one or more processors, direct a computing apparatus to detect an operational anomaly in a wireless network based on error code information and capture network operations data and contextual information relating to the operational anomaly. The program instructions further direct the computing apparatus to prompt an AI model to identify a root cause of the operational anomaly based on the error code information, the network operations data, and the contextual information and to receive output from the AI model including a root cause analysis of the operational anomaly.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for an AI-based system for root cause analyses of operational anomalies on wireless networks in an implementation.

FIG. 2 illustrates a process for an AI-based system for root cause analyses of operational anomalies on wireless networks in an implementation.

FIG. 3 illustrates a system architecture for an AI-based system for root cause analyses of operational anomalies on wireless networks in an implementation.

FIG. 4 illustrates a workflow for an AI-based system for root cause analyses of operational anomalies on wireless networks in an implementation.

FIG. 5 illustrates an operational architecture of a wireless communication network in an implementation.

FIG. 6 illustrates an operational architecture for a wireless communication network in an implementation.

FIG. 7 illustrates a computing system suitable for implementing the various operational environments, architectures, processes, scenarios, and sequences discussed below with respect to the other Figures.

### DETAILED DESCRIPTION

In a wireless communication network, transactions across the interfaces of network functions are monitored using probes which capture packet traces of the transactions. When an issue arises on the network, such as when there is a significant increase in the rate or number of transactional alarms, troubleshooting the issue will involve capturing and analyzing transaction records from various interfaces at network elements affected by the issue. Often, when a malfunction occurs at a core element in the network, the failure propagates and causes a chain-reaction of other failures at other locations in the network. As such, multiple alarms or error codes may be thrown from different sources nearly simultaneously, and often the patterns or groupings of error codes form a signature by which the root cause can be diagnosed. To identify the root cause underlying the multiple alarms, the error codes are collected and evaluated along with network operations data, such as packet capture (PCAP) traces of network transactions, to diagnose and resolve the issue.

Diagnosing a network failure involves ingesting information from a number of different sources. A network operator or administrator with the appropriate experience (e.g., institutional or domain knowledge and practical experience) can develop expertise or intuition in diagnosing a failure in a particular domain of the network, but often the diagnosis involves a coordinated effort among multiple such experts. Moreover, when a failure is detected, a large quantity of detailed information may be captured for analysis, but much of the data captured may end up being irrelevant (i.e., useless), resulting in wasted time and resources. In addition, the knowledge and expertise that an individual may have in a particular domain of the network cannot be replicated to another individual without a significant investment in training and practical experience in the field. Thus, the network may develop a heavy reliance on a particular group of experts who continue to grow and improve their ability to diagnose network failures but with no mechanism for disseminating such knowledge to reduce risks associated with relying on any one expert.

Technology is disclosed herein for a deep learning-based system for diagnosing the root cause of an error or group of errors in wireless network hosting IP Multimedia Subsystem (IMS) and data service based on network diagnostic information. In various implementations, an artificial intelligence (AI) model may be trained to diagnose the root cause based on transactional alarm or error code information resulting from the error(s) along with network operations data and contextual information. The network operations data can include detailed records of transactions (e.g., PCAP traces) at interfaces that are implicated by the error codes at the time of the failure. Such information may be filtered to produce a dataset of the most relevant information to minimize the possibility of distracting the model with irrelevant information. Contextual information supplied to the AI model may include signaling protocol (e.g., Hypertext Transfer Protocol (HTTP), Session Initiation Protocol (SIP), Diameter) information, network architecture information (e.g., a network topology map), network performance parameters (e.g., key performance parameters or KPIs), records of activity at specific network elements or functions such as downtime or loss of connectivity, software changes such as updates, and so on. In some scenarios, Retrieval Augmented Generation (RAG) is performed in which relevant contextual information is identified and retrieved for the AI model to provide a more focused and relevant analysis. Capturing the relevant contextual information may be based on information such as where the alarms were raised and/or the types of errors that were detected.

In some implementations, the AI model may be trained to diagnose network failures based on historical information of failures at various nodes of the network. The historical information may include patterns or groupings of alarms or error codes which arose at the time of a network failure and the corresponding operations data and contextual information by which the failure was diagnosed. The model may then be trained to correlate patterns or groupings of error codes and the corresponding operations data and contextual information to identify a root cause of a failure, such as the one or more nodes of the network that are likely to be the source of the network failure. In some implementations, the AI model may be a generative AI model which has been pretrained or fine-tuned for diagnosing network failures based on the historical information of failures at various nodes of the network. In some cases, the generative AI model may be a multi-modal model capable of receiving text as well as image data, such as images which include visual representations data traffic through the network.

In various implementations, the network operations data supplied to the AI model includes PCAP trace records generated by packet sniffers which capture detailed records of transactions across the network. These records captured at multiple locations in the network may be concatenated to form an end-to-end call flow. Because the PCAP raw data can be heavily detailed (e.g., with IP addresses, protocols, ports, timestamps), to facilitate the analysis of the network failure, the network operations data may be filtered to remove extraneous information to produce a set of data that is relevant to the specific analysis or purpose, thereby reducing the volume of data to be ingested by the model. For example, a reduced information set (RIS) may be generated from the raw data of PCAP traces which has been aggregated and filtered to provide a subset of the data for a forensic analysis in the event of a network malfunction. In some scenarios, the transaction records for call flows may be rendered in a text-based format for ingestion and analysis by an AI model capable of semantic or natural language understanding, such as a generative AI model.

Generative AI models of the technology disclosed herein include large-scale foundation models trained on massive quantities of diverse, unlabeled data using self-supervised, semi-supervised, or unsupervised learning techniques. Such models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. Foundation models include BERT (Bidirectional Encoder Representations from Transformers) and ResNet (Residual Neural Network). In some scenarios, a foundation model such as a generative AI model may be fine-tuned for a specific downstream task, such as performing a root cause analysis based on network error codes and operations data. Fine-tuning a foundation model involves adjusting the parameters of the pretrained model according to a specific dataset to adapt the model's output to a particular task. Types of foundation models may be broadly classified as or include pre-trained models, base models, and knowledge models, depending on the particular characteristics or usage of the model. Foundation models may be multimodal or unimodal depending on the modality of the inputs.

Large language models (LLMs) are a type of foundation model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Such pretraining allows the models to learn a rich representation of language that can be fine-tuned for specific NLP tasks, such as text generation, language translation, or sentiment analysis.

Technical effects of the technology disclosed herein include a streamlined process for diagnosing the root cause of a network failure by an AI-based system capable of natural language processing to perform data analysis based on network operations data and alarm-related contextual information. By using an AI-based system, the process of information identification and capture can be automated to generate prompts for an AI model to identify the particular element(s) of the network where the failure originated. Because such models are capable of ingesting a tremendous amount of data at once, the forensic analysis can be performed more quickly which in turn facilitates resolution of the failure and improves network reliability. Moreover, as more datasets of operational anomalies are captured, the AI model can be continually updated to improve its diagnostic capabilities. Importantly, with an AI model in place to diagnose anomalies, the reliance on human experts for troubleshooting operational anomalies is alleviated.

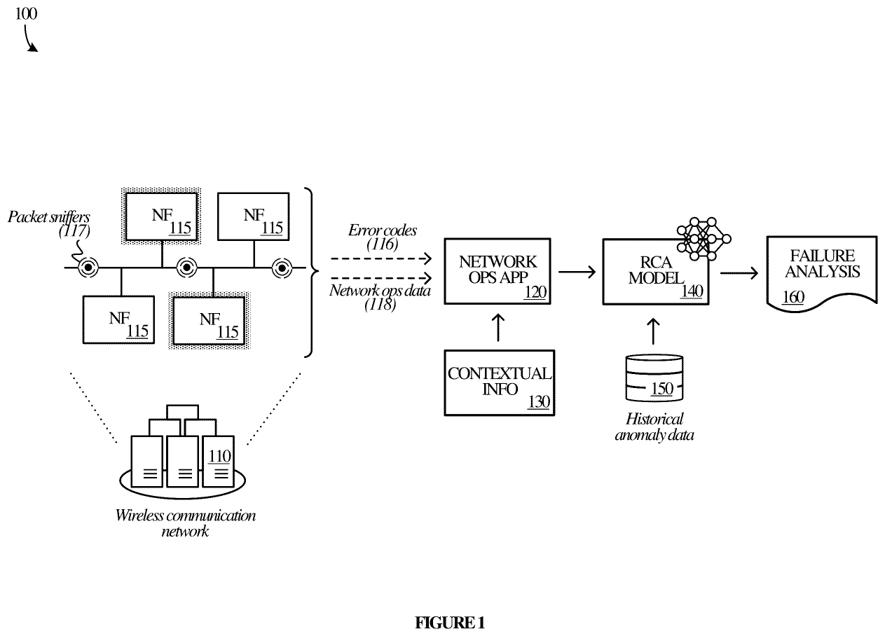

Turning now to the Figures, FIG. 1 illustrates operational environment 100 for an AI-based system for root cause analyses of operational anomalies in a wireless network in an implementation. Operational environment 100 includes wireless communication network 110 (“wireless network 110”) which includes various network functions 115 and packet sniffers 117. Operational environment 100 also includes network operations application 120 which detects operational anomalies based on error codes 116 received from various ones of network functions 115 and root cause analysis (RCA) model 140 which receives network operations data 118 and contextual information 130 and outputs failure analysis 160. Operational environment 100 also includes historical anomaly data 150 on which RCA model 140 is trained.

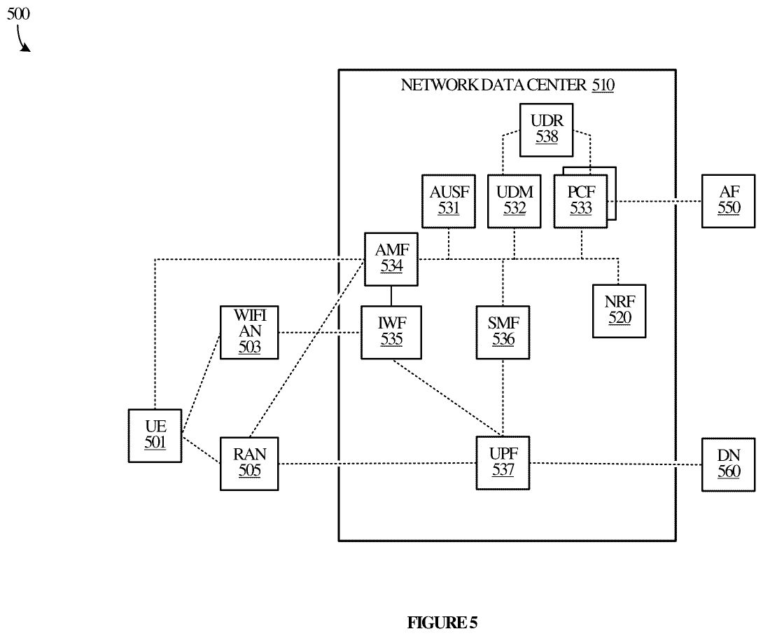

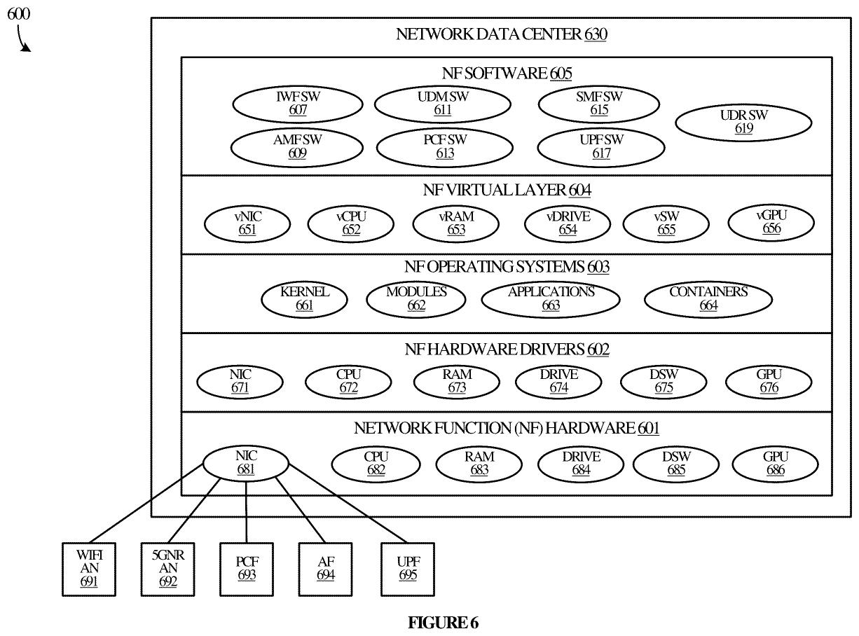

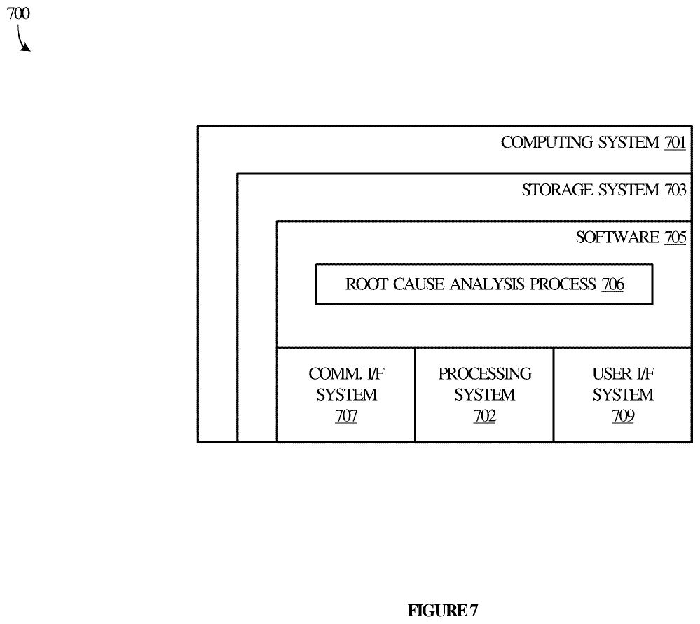

Wireless network 110 is representative of a communication network capable of using a Fifth Generation New Radio (5 G-NR), 5G Advanced, 6G, LTE, or other protocol to provide network connectivity for wireless IMS and data service to wireless communication devices (not shown). In an implementation, wireless network 110 is representative of a service-based architecture (SBA) which includes network functions 115 constituting the control plane and user plane elements of a wireless communication network core, of which network data center 510 of FIG. 5 and network data center 630 of FIG. 6 are representative. Network functions 115 of wireless network 110 are implemented on one or more suitable computing devices, of which computing device 701 of FIG. 7 is representative. Examples of suitable computing devices include server computers, blade servers, and the like. Network elements 115 of wireless network 110 may be implemented in the context of one or more data centers in a co-located or distributed manner, or in some other arrangement.

Network operations application 120 is representative of a software application which receives error codes, cause codes, and/or alarms signals from elements of wireless network 110 indicating an operational anomaly in wireless network 110. Network operations application 120 communicates with RCA model 140 including transmitting prompts which task RCA model 140 with identify root causes of detected anomalies. In some scenarios, network operations application 120 may display a user interface including visual indications of error codes 116 and network operations data 118. For example, when a transaction completion metric at one or more of network functions 115 exceeds a threshold, network operations application 120 may display a visual indication of the anomalous behavior in the user interface. In various scenarios, when an anomaly is detected, network operations application 120 generates a prompt including error code information, selected portions of network operations data 118, and contextual information 130. The prompt tasks RCA model 140 with performing an analysis to identify the root cause(s) of the anomaly in accordance with its training.

RCA model 140 is representative of an AI model for diagnosing a root cause of an operational anomaly on wireless network 110. RCA model 140 may be a trained neural network architecture which receives inputs including error codes or cause codes thrown by various ones of network functions 115, network operations data 118, and contextual information 130, and which is tasked with analyzing the inputs to determine a causality for the operational anomaly. To diagnose operational anomalies, RCA model 140 may be trained using historical anomaly data 150.

In various implementations, RCA model 140 is a generative AI model capable of natural language processing and semantic understanding. For example, RCA model 140 may be a multi-modal model, such as a multi-modal large language model, which can receive textual input as well as imagery data in a prompt to complete a task, such as a root cause analysis. In some scenarios, RCA model 140 may be pretrained or fine-tuned to identify root causes of operational anomalies in wireless networks based on historical anomaly data 150.

In operation, RCA model 140 receives prompts from network operations application 120 which task the model with identifying one or more root causes of an operational anomaly based at least on network operations data 118 and contextual information 130. Network operations data 118 received by RCA model 140 may be based on PCAP trace records captured by packet sniffers 117 which have been filtered to remove nonessential details and transformed into a human-readable format. Contextual information 130 may include information or data from databases such as cause code specifications, software updates relating to various ones of network functions 115 throwing cause codes, and a textual description or visual representation (e.g., a map) of the topology of network functions 115. Upon completing an analysis of the input data, RCA model 140 returns failure analysis 160 including one or more root causes of the detected anomaly to network operations application 120.

Historical anomaly data 150 is representative of a network function or element of wireless network 110 which stores historical data relating to network anomalies and their root causes. In various implementations, historical anomaly data 150 includes data relating to anomalous operation events which occurred on wireless network 110 and which have been correlated to root causes. Data relating to historical anomaly events may include patterns or groupings of error codes, cause codes, or alarms of the events, network operations data associated with the events, contextual information associated with the events, and the root cause(s) of the events. Historical anomaly data 150 may be implemented on one or more suitable computing devices, of which computing device 701 of FIG. 7 is representative.

In a brief operational scenario of operational environment 100, network operations application 120 monitors operations of network functions 115 of wireless network 110, including receiving error codes 116 thrown by various ones of network functions 115 and network operations data 118 captured by packet sniffers 117.

When network operations application 120 determines that one or more transaction completion metrics, such as a transaction success or failure percentage, have exceeded a threshold, network operations application 120 prompts RCA model 140 to identify a root cause of the operational anomaly giving rise to the anomalous behavior. The prompt to RCA model 140 includes input data such as network operations data 118 and contextual information 130 along with information relating to error codes 116. The prompt tasks RCA model 140 with evaluating the information to determine a root cause, such as a particular element or elements of wireless network 110 triggering error codes 116.

Based on its training, RCA model 140 ingests the input data of the prompt and, in accordance with its training on historical anomaly data 150, generates output identifying one or more root causes of the anomalous behavior associated with error codes 116, such as identifying a type of malfunction of one of network functions 115 which triggered a cascade of error codes 116. RCA model 140 returns failure analysis 160 to network operations application 120 including the output generated by the model; network operations application 120 may display the substance of failure analysis 160 in a user interface so a user such as a network administrator can resolve the anomalous behavior.

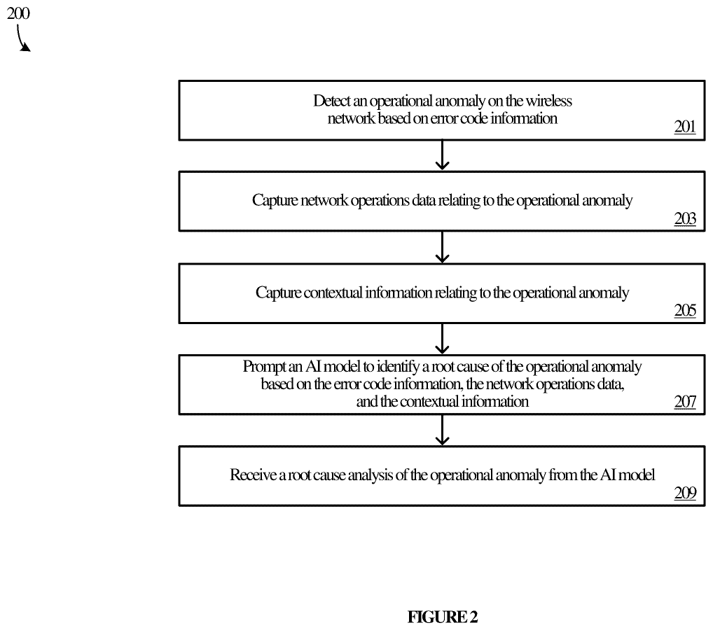

FIG. 2 illustrates a process for an AI-based system for root cause analyses of operational anomalies in a wireless network in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, a computing device detects an operational anomaly on the wireless network based on error code information (step 201). In an implementation, the computing device executes a network operations application which receives data including signals indicating the status (e.g., status codes, error codes, alarms) of network functions and operational data relating to transactions on the network. The computing device detects an operational anomaly based on receiving status signals from one or more network functions indicating some anomalous or unexpected behavior at the functions. For example, the computing device may receive a higher-than normal level or percentage of signals or error codes from a network function over a specified period of time indicating unexpected or anomalous behavior.

In an exemplary scenario illustrating process 200, a Unified Data Management function (UDM) of the wireless network experiences a critical failure when a user equipment (UE) attempts to establish a connection with the network. An Access and Mobility Management Function (AMF) requesting subscriber data from the UDM does not receive a response from the UDM and returns a SIP “500 Internal Server Error” code to the computing device (e.g., to the network operations application). As the failure cascades through the network, a Session Management Function (SMF) generates a SIP “504 Gateway Timeout” upon failing to obtain subscriber data from the UDM and an Authentication Server Function (AUSF) generates a SIP “401 Unauthorized” error indicating a failure to authenticate due to the inability to retrieve the necessary data. As other UEs fail to attach to the network, the computing device receives the multiple error codes indicating unexpected behavior by one or more of the network functions and determines that an operational anomaly has occurred or is occurring. The network operations application may display an indication of anomalous or unexpected behavior in a user interface of the application.

The computing device captures network operations data relating to the operational anomaly (step 203). In various implementations, the computing device receives transaction data such as PCAP trace records captured by packet sniffers on the network and aggregates the PCAP traces to form end-to-end call flows. The PCAP trace records may be rendered in a textual format for display in a user interface and for ingestion by an AI model for identifying the root cause of the operational anomaly.

In an implementation, the network operations data (e.g., PCAP trace data) is filtered to provide the model to remove nonessential information to reduce or optimize the quantity of information supplied to the model and to avoid distracting the model with unnecessary information. To remove the nonessential information, the network operations data may be filtered according to when the operational anomaly occurred and the network functions in the network which threw error codes, removing transaction records which are not relevant to the operational anomaly by way of time or location of the anomaly or the downstream effects of the anomaly. Referring to the exemplary scenario above, the PCAP trace data may be filtered to capture transactions at the N10, N11, and N12 interfaces of the AMF, SMF, AUSF, and UDM at the time the error codes were generated. The PCAP trace records may also be filtered to remove nonessential details from the records.

The computing device captures contextual information relating to the operational anomaly (step 205). In an implementation, the computing device may access various databases to provide the AI model with contextual information which may be relevant to diagnosing the root cause of the anomaly. For example, the computing device may capture error code definitions of the appropriate protocol or specification (e.g., Third Generation Partnership Project (3GPP), Internet Engineering Task Force (IETF)). The computing device may also capture information relating to the network topology or information relating to the communication paths between the network functions such as pathways for successful end-to-end call flows. Other contextual information may include event logs of the network functions which transmitted the error codes or which are directly connected to the alarming network functions. Event log data may include information such as the current status of or any changes made to operational parameters of the network function, downtime, loss of connectivity, software updates, other past performance issues of network functions, and the like. Referring to the exemplary scenario above, the network operations application may capture contextual information associated with the AMF, SMF, and AUSF as the network functions which have thrown error codes.

In an implementation, the computing device selects data for RAG by the AI model. In RAG, the prompt to the AI model is augmented with information obtained from a targeted search for relevant contextual information, resulting in a response which is more focused and relevant to the prompt task and which constrains the model to operate within a particular domain of the network by providing domain-specific information. To obtain an AI-generated response using RAG, relevant information from databases or knowledge bases of contextual information is retrieved based on a targeted search. Populating the prompt with information retrieved based on a targeted search provides the AI model with up-to-date information that is specific to the anomaly, improving the quality and relevance of the generated output. For troubleshooting an operational anomaly on a wireless network, RAG can be used to obtain an AI-generated answer to the query about the anomaly by first retrieving relevant information from technical documents, knowledge bases, or previous queries related to wireless networks. This retrieved context, which may include details on network protocols, common issues, and troubleshooting steps, is then incorporated into the prompt to the AI model. As a result, the AI model can generate more accurate and contextually relevant output which can be used to resolve the anomaly.

To execute a targeted search of contextual information, the network operations application may perform a similarity search such as a keyword search of contextual information databases based on selected keywords derived from information about the operational anomaly, such as the network functions throwing the error codes, the type or nature of error codes that were thrown, and the like. In some cases, a cosine or vector similarity search may be performed based on embeddings of the operational anomaly data and the database information to identify relevant contextual information.

The computing device prompts an AI model to identify a root cause of the operational anomaly based on the error code information, the network operations data, and the contextual information (step 207). In an implementation, the computing device generates a prompt for an AI model to diagnose the cause of the operational anomaly based on the error codes or signals received, network operations data and the contextual information. In various implementations, the AI model is a generative AI model capable of natural language processing and semantic understanding. The model may be tasked to identify one or more causes of the operational anomaly based on the information supplied in the prompt. In reference to the exemplary scenario described above, the AI model determines that the error codes, filtered PCAP traces, and other contextual information indicate that the operational anomaly was triggered by a failure event at the UDM along with the type of failure.

In various implementations, the AI model may be trained to correlate patterns or groupings of error code events and other information to one or more causalities where the causalities include one or more network functions identified as causing or likely to be causing the anomalous behavior and the type of malfunction or failure which occurred.

In response to prompting the AI model to identify the root cause of the operational anomaly, the computing device receives output including a failure analysis performed by the AI model based on the information in the prompt (step 209). The root cause or failure analysis may identify one or more root causes which caused or which are likely to have caused the operational anomaly. The failure analysis may also include a diagnose of the type of failure which triggered the anomaly, such as a hardware failure, software failure, security breach, or other event. The output may be displayed, for example, in a user interface of the network operations application and/or stored for use in subsequent training of the AI model.

Referring again to FIG. 1, operational environment 100 illustrates a brief example of process 200 as employed by elements of operational environment 100. In operation, network operations application 120 detects an operational anomaly which has occurred on wireless network 110 based at least on receiving error codes 116 from various ones of network functions 115. To diagnose the source of the anomaly, network operations application 120 captures information relating to the anomaly for prompting RCA model 140 to identify one or more root causes of the anomaly.

The information captured by network operations application 120 includes network operations data 118 including records of transactions occurring before various ones of network functions 115, including the functions transmitting error codes 116, at or around the time of the operational anomaly. In various implementations, network operations data 118 is filtered and processed for input to RCA model 140. The information captured by network operations application 120 also includes contextual information 130 relating to the operational anomaly. In an implementation, a RAG process is performed whereby network operations application 120 executes a targeted search for relevant data of contextual information 130 for the root cause analysis to be executed by RCA model 140 as described above.

Network operations application 120 generates a prompt for RCA model 140 which tasks the model with analyzing the information supplied in the prompt to diagnose a root cause of the operational anomaly. In various implementations, RCA model 140 may host an application programming interface (API) by which network operations application 120 communicates with RCA model 140, including submitting prompts to RCA model 140 and receiving output from the model. Upon receiving the prompt, RCA model 140 ingests the information in the prompt, performs an analysis of the information in accordance with its training, and returns the results of the analysis to network operations application 120. The task specified in the prompt may direct RCA model 140 to identify one or more locations in wireless network 110 where the operational anomaly was triggered or was likely to have been triggered. The prompt may also direct RCA model 140 to diagnose the type or nature of the failure which was likely to have occurred. Upon receiving the output generated by RCA model 140, network operations application 120 may display the output in a user interface, enabling network administrators to take appropriate action to resolve the anomaly.

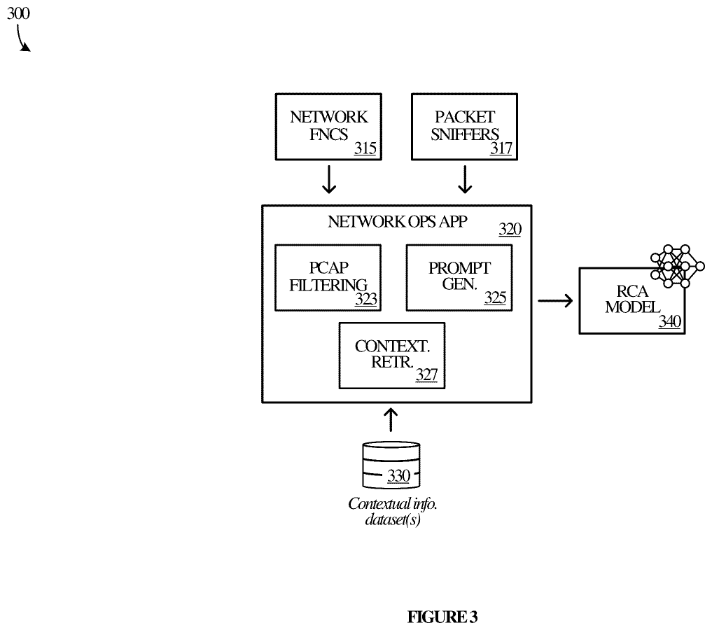

Turning now to FIG. 3, FIG. 3 illustrates system architecture 300 for an AI-based system for diagnosing operational anomalies on wireless communication networks in an implementation. System architecture 300 includes network operations application 320 including PCAP filtering module 323, prompt generator 325, and context retrieval module 327. Network operations application 320 receives input from network functions 315, packet sniffers 317, and contextual information dataset(s) 330. Network operations application 320 communicates with RCA model 340 including transmitting input for an analysis by the model and receiving output generated by the model in response to the input.

Network operations application 320 is representative of a software application or program for identifying root causes of operational anomalies on wireless networks. Network operations application 320 receives status codes, error codes, cause codes, and/or alarms signals from various ones of network functions 315 indicating an operational anomaly in the wireless network. Network operations application 320 communicates with RCA model 340 including transmitting prompts which task RCA model 340 with identify root causes of detected anomalies on the wireless communication network. For example, when an anomaly is detected of the wireless network, network operations application 320 generates a prompt including error code information, selected portions of network operations data, and contextual information. The prompt tasks RCA model 340 with performing an analysis to identify the root cause(s) of the anomaly in accordance with its training.

Network operations application 320 includes various software functionalities for performing services with respect to network operations, such as PCAP filtering 323, prompt generator 325, and contextual retrieval module 327. In an implementation, PCAP filtering 323 filters and processes PCAP traces from packet sniffers 317 to produce a reduced information set (RIS) for ingestion by RCA model 340. For example, to produce an RIS, PCAP filtering 323 may extract the particular data transaction records received which are relevant to the detected anomaly, extract the relevant details of the extracted records, and process the extracted records to produce a text-based dataset of network operations data which can be ingested by a model capable of natural language processing.

Prompt generator 325 of network operations application 320 is representative of a software functionality for generating prompts for input to RCA model 340. Prompt generator 325 may include one or more prompt templates by which to task RCA model 340 with diagnosing a cause or likely cause of an operational anomaly based on error codes, transaction records, contextual information, and the like supplied in the prompt.

Contextual retrieval module 327 of network operations application 320 is representative of software functionality for retrieving contextual information for input to RCA model 340. In an implementation, contextual retrieval module 327 searches various ones of contextual information dataset(s) 330 to retrieve relevant contextual information by which RCA model 340 can perform a root cause analysis of the operational anomaly.

Network functions 315 are representative of elements of a service-based architecture of a wireless communication network in which network functions 315 form the control plane and user plane elements of the network core, of which network data center 510 of FIG. 5 and network data center 630 of FIG. 6 are representative. Network functions 315 are implemented on one or more suitable computing devices, of which computing device 701 of FIG. 7 is representative.

RCA model 340 is representative of an AI model for diagnosing a root cause of an operational anomaly on a wireless network. RCA model 340 may be a trained neural network architecture which receives inputs including error codes or cause codes thrown by various ones of network functions 315, PCAP traces captured by packet sniffers 317, and contextual information selected from contextual information dataset(s) 330. RCA model 340 may be tasked with analyzing the inputs to determine a causality for the operational anomaly on the network. To diagnose operational anomalies, RCA model 340 may be trained using historical anomaly data including error codes, PCAP trace data, and relevant contextual information correlated to diagnosed anomalies.

In various implementations, RCA model 340 is a generative AI model capable of natural language processing and semantic understanding. For example, RCA model 340 may be a multi-modal model, such as a multi-modal large language model, which can receive textual input as well as imagery data in a prompt to complete a task, such as a root cause analysis. In some scenarios, RCA model 340 may be pretrained or fine-tuned to identify root causes of operational anomalies in wireless networks based on the historical anomaly data.

Contextual information dataset(s) 330 is/are representative of datasets or databases of information relating to network operations. Contextual information dataset(s) include information such as technology protocols and specifications (e.g., 3GPP, IETF) governing the operation of the wireless network (e.g., error code definitions), network design or topology information, event history in relation to network functions 315 (e.g., downtime, loss of connectivity, software changes, maintenance), operational parameters or key performance indicators of network functions 315, transaction flows during normal network operation, and the like.

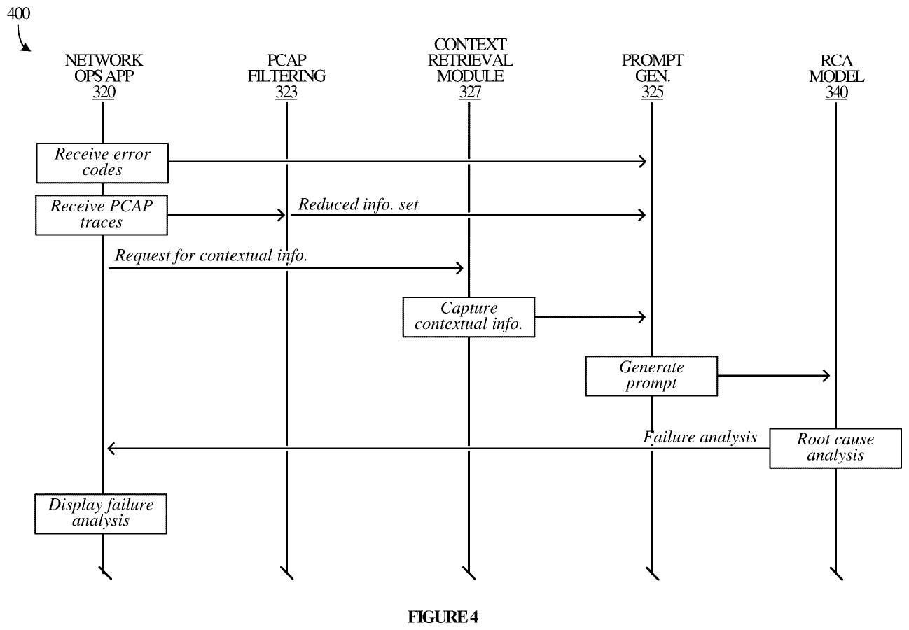

FIG. 4 illustrates workflow 400 for performing a root cause analysis of an operational anomaly on a wireless network in an implementation and referring to elements of system architecture 300. Network operations application 320 monitors operations on the network including receiving status information from network functions 315 and PCAP trace records from packet sniffers 317.

In an exemplary scenario, network operations application 320 receives error codes resulting from an operational anomaly somewhere on the network. Based on detected the anomaly, network operations application 320 initiates workflow 400 for diagnosing the anomaly. In workflow 400, prompt generator 325 of network operations application 320 receives the error code information and captures other information for generating a prompt for RCA model 340. PCAP filtering 323 receives PCAP trace records and generates a RIS of the PCAP trace records by filtering and processing the records to produce a filtered set of trace data in a text-based, natural language, or human-readable format. Network operations application 320 executes context retrieval module 327 to obtain relevant contextual information from contextual information dataset(s) 330 which performs a keyword or similarity search of various ones of the dataset(s) to identify and retrieve the relevant contextual information. Prompt generator 325 receives the RIS from PCAP filtering 323 and the relevant contextual information from context retrieval module 327 and, together with the error code information, generates a prompt for submission to RCA model 340.

Upon receiving the prompt from network operations application 320, RCA model 340 ingests the information in the prompt and performs a root cause analysis to diagnose the one or more root causes of the anomaly. For example, RCA model 340 may be tasked with identifying a network function of network functions 315 where the anomaly originated and diagnosing the error or malfunction which caused the anomaly. RCA model 340 generates output as instructed by the prompt and in accordance with its training and returns the results of the root cause analysis to network operations application 320. In various implementations, network operations application 320 receives the output generated by RCA model 340 in response to the prompt and displays the output, e.g., the failure analysis in a user interface of the application.

In some implementations, based on its training, RCA model 340 may be used to identify issues arising during load testing of a network function of the network. For example, RCA model 340 may be trained on historical anomaly data which includes load testing scenarios at different network functions. When load testing is executed at a location on the network, this may lead to a spike in one or more transaction metrics (e.g., transaction failure percentage) which in turn triggers evaluation of transaction records and error codes by RCA model 340. RCA model 340 may then return a root cause analysis which indicates a location on the network where load testing occurred.

FIG. 5 illustrates exemplary wireless communication system 500 that serves wireless User Equipment (UE) 501. Wireless communication system 500 includes UE 501, Wifi Access Node (AN) 503, 5GNR RAN 505, Interworking Function (IWF) 535, Access and Mobility Management Function (AMF) 534, Authentication Server Function (AUSF) 531, Unified Data Management (UDM) 532, Policy Control Functions (PCFs) 533, Session Management Function (SMF) 536, User Plane Function (UPF) 537, Uniform Data Repository (UDR) 538, and Application Function (AF) 550. IWF 535 includes non-3GPP IWFs (N3IWFs) for providing untrusted non-3GPP access to network data center 510, such as access via a non-cellular access network.

In an implementation, UE 501 communicates with network data center 510 via 5G-NR access node 505 or Wifi access node 503. UE 501 requests access to DN 560 via the communication network of network data center 710. SMF 536 receives the access request from AMF 534 and other network functions of the communication network which are enforcing various aspects of the access request from UE 501. SMF 536 receives policies or policy decisions from AUSF 531, UDM 532, PCF 533, and/or AMF 534.

FIG. 6 illustrates exemplary network data center 630, a network core of a wireless communication system, of which wireless network 110 of FIG. 1 is representative. Network data center 630 includes network function (NF) software 605, network function virtual layer 604, network function operating systems 603, network function hardware drivers 602, and network function hardware 601.

Network function software 605 of network data center 630 includes software for executing various network functions: IWF software 607, AMF software 609, UDM software 611, PCF software 613, SMF software 615, UPF software 617, and UDR software 619. Other network function software, such as network repository function (NRF) software, are typically present but are omitted for clarity.

Network function virtual layer 604 includes virtualized components of network data center 630, such as virtual NIC 651, virtual CPU 652, virtual RAM 653, virtual drive 654, virtual software 655, and virtual GPU 656. Network operating systems 603 includes components for operating network data center 630, including kernels 661, modules 662, applications 663, and containers 664 for network function software execution. Network function hardware drivers 602 include software for operating network function hardware 601 of network data center 630, including network interface card (NIC) drivers 671 for network interface cards (NICs) 681, CPU drivers 672 for CPUs 682, RAM drivers 673 for RAM 883, flash/disk drive drivers 674 for flash/disk drives 684, data switch (DSW) drivers 675 for data switches 685, and drivers 676 for GPUs 686. Network interface cards 681 of network function hardware 601 include hardware components for communicating with Wifi access node 691, 5GNR access node 692, PCF 693, application server 694, and UPF 695.

FIG. 7 illustrates computing device 701 that is representative of any system or collection of systems in which the various processes, programs, services, and scenarios disclosed herein may be implemented. Examples of computing device 701 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements root cause analysis process 706, which is (are) representative of the root cause analysis processes discussed with respect to the preceding Figures, such as process 200 and workflow 400. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including root cause analysis process 706) may be implemented in program instructions and among other functions may, when executed by processing system 702, direct processing system 702 to operate as described with respect to the various operational scenarios, sequences, and processes illustrated herein. For example, software 705 may include program instructions for implementing a root cause analysis process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support root cause analysis processes of operational anomalies in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
detect an operational anomaly in a wireless network based on error code information;
capture network operations data relating to the operational anomaly;
capture contextual information relating to the operational anomaly;
prompt an artificial intelligence (AI) model to identify a root cause of the operational anomaly based on the error code information, the network operations data, and the contextual information; and
receive, from the AI model in response to the prompt, output comprising a root cause analysis of the operational anomaly.

2. The computing apparatus of claim 1, wherein the error code information comprises an indication that a transaction completion metric of the wireless network exceeds a respective threshold.

3. The computing apparatus of claim 2, wherein the transaction completion metric comprises a quantity of error codes associated with a network function of the wireless network within a given period of time.

4. The computing apparatus of claim 1, wherein the network operations data comprises packet capture trace records of transactions on the wireless network.

5. The computing apparatus of claim 1, wherein the network operations data comprises a reduced information set based on filtered packet capture trace records.

6. The computing apparatus of claim 4, wherein the program instructions further direct the computing apparatus to filter out nonessential information from the packet capture trace records resulting in the filtered packet capture trace records.

7. The computing apparatus of claim 1, wherein the AI model is trained to correlate root causes of network anomalies to network operations data based on a historical operational anomaly dataset.

8. The computing apparatus of claim 7, wherein the historical operational anomaly dataset comprises identified root causes of historical operational anomalies correlated to historical network operations data.

9. A method of operating a computing device comprising:
detecting an operational anomaly in a wireless network based on error code information;
capturing network operations data relating to the operational anomaly;
capturing contextual information relating to the operational anomaly;
sending, to an artificial intelligence (AI) model, a prompt which tasks the AI model with identifying a root cause of the operational anomaly based on the error code information, the network operations data, and the contextual information; and
receiving, from the AI model in response to the prompting, output comprising a root cause analysis of the operational anomaly.

10. The method of claim 9, wherein the error code information comprises an indication that a transaction completion metric of the wireless network exceeds a respective threshold.

11. The method of claim 10, wherein the transaction completion metric comprises a quantity of error codes associated with a network function of the wireless network within a given period of time.

12. The method of claim 9, wherein the network operations data comprises packet capture trace records of transactions on the wireless network.

13. The method of claim 9, wherein the network operations data comprises a reduced information set based on filtered packet capture trace records.

14. The method of claim 12, further comprising filtering out nonessential information from the packet capture trace records resulting in the filtered packet capture trace records.

15. The method of claim 9, wherein the AI model is trained to correlate root causes of network anomalies to network operations data based on a historical operational anomaly dataset.

16. The method of claim 15, wherein the historical operational anomaly dataset comprises identified root causes of historical operational anomalies correlated to historical network operations data.

17. One or more computer readable storage media having program instructions stored thereon that, when executed by one or more processors, direct a computing apparatus to at least:
detect an operational anomaly in a wireless network based on a transaction completion metric;
generate a reduced information set relating to the operational anomaly;
capture contextual information relating to the operational anomaly;
prompt an artificial intelligence (AI) model to identify a root cause of the operational anomaly based on the transaction completion metric, the reduced information set, and the contextual information; and
receive, from the AI model in response to the prompt, output comprising a root cause analysis of the operational anomaly.

18. The one or more computer readable storage media of claim 17, wherein to detect the operational anomaly in the wireless network based on the transaction completion metric, the program instructions direct the computing apparatus to determine that the transaction completion metric of the wireless network exceeds a threshold and wherein the transaction completion metric comprises a quantity of error codes received from a network function of the wireless network within a given period of time.

19. The one or more computer readable storage media of claim 17, wherein the reduced information set comprises transaction data extracted from packet capture trace records and formatted in a natural language format.

20. The one or more computer readable storage media of claim 17, wherein the AI model is trained to correlate root causes of network anomalies to network operations data based on identified root causes of historical operational anomalies correlated to historical network operations data.
